(19) United States
(12) Patent Application Publication
(10) Pub. No.: US 2019/0160759 A1
(43) Pub. Date: May 30, 2019

(54) JOINING METHOD FOR THERMOPLASTIC ELEMENTS

(71) Applicant: Airbus Operations, S.L., Getafe (ES)

(72) Inventors: Jesús Javier Vázquez Castro, Getafe (ES); Melania Sánchez Pérez, Getafe (ES); Zulima Martìn Moreno, Getafe (ES); Asunción Butragueño Martínez, Getafe (ES)

(21) Appl. No.: 16/195,171

(22) Filed: Nov. 19, 2018

(30) Foreign Application Priority Data
Nov. 24, 2017 (EP) 17382797.3

(51) Int. Cl. B29C 65/00; B29C 51/02; B29C 65/34

(52) U.S. Cl. CPC B29C 66/73921; B29C 51/02; B29L 2031/3076; B29C 65/3492; B29C 65/3444

(57) ABSTRACT

A joining method for thermoplastic elements that comprises the steps of providing two thermoplastic parts having two surfaces to be joined, locating a graphene layer between the two thermoplastic parts adjacent to the surfaces to be joined, and heating the graphene layer such that the graphene layer melts the thermoplastic resin of the adjacent surfaces of the two thermoplastic parts that are to be joined.

### CROSS-REFERENCES TO RELATED APPLICATIONS

This application claims the benefit of the European patent application No. 17382797.3 filed on Nov. 24, 2017, the entire disclosures of which are incorporated herein by way of reference.

### FIELD OF THE INVENTION

The invention is related to a welding method for joining two thermoplastic elements, specially adapted for the aircraft industry.

### BACKGROUND OF THE INVENTION

Manufacturing and joining by welding thermoplastic parts is known in the state of the art. One of the main advantages offered by a method of joining thermoplastic elements by a welding process is the possibility to join parts without the need of rivets or fasteners.

However, nowadays there are no industrialized welding processes for complex or thick structural aeronautical joints that assure a uniform welded interface without impact in the mechanical properties of the interface.

There are several heating technologies for thermoplastic welding (induction, resistive, ultrasonic, friction . . . ) but all of them have constraints for aeronautical structural applications in which resins such as polyetherketoneketone (PEKK), polyether ether ketone (PEEK) etc., are needed. A homogenous and focused heating in the interface must be assured, as well as good mechanical properties, that known processes, such as spot welding, do not achieve.

For continuous joints, ultrasonic welding has limitations in its application (thickness . . . ), induction/resistive welding normally needs metallic inserts embedded in the interface. Also, friction stir welding has a big impact in interface mechanical properties.

### SUMMARY OF THE INVENTION

An object of the invention comprises the following steps:

providing two thermoplastic parts to be joined,

locating a graphene layer between the two thermoplastic parts adjacent to the surfaces to be joined, the graphene layer may or may not be preimpregnated with resin,

heating the graphene layer such that the graphene layer melts the thermoplastic resin of the adjacent surfaces of the two thermoplastic parts that are joined.

Therefore, the invention proposes to use a graphene layer located at the interface of the two thermoplastic parts to be joined as a heater that will melt the thermoplastic resin of the adjacent areas of the two parts. The graphene layer is integrated in the structure during the welding process, directly heating the thermoplastic surfaces to be welded.

An objective of the invention is to provide a feasible welding process for structural thermoplastic having the following advantages:

reducing the assembly time of the joining,

providing a method that is easy to perform at shop floor level,

reducing the number of parts and therefore achieving a part count reduction and subsequent assembly process, by the integration of at least two parts into one only piece,

enabling a thermoplastic technology that has advantages in different fields as environmental, recyclability,

enable reparability, typically repairs in thermoplastic are quite difficult but with the invention reparability is feasible,

drag reduction at the aerodynamic surface due to the absence of fastener heads.

The claimed process will be applicable for any part made with thermoplastic resins.

According to the above mentioned, the claimed invention proposes to use a heating source based on a graphene layer located at the interface of the two thermoplastic parts to be joined. Heating the graphene layer will melt the thermoplastic resin of the adjacent areas of the two thermoplastic parts to be joined.

One of the advantages of using a graphene layer its flexibility, i.e., it can be easily bent, and hence the layer is able to be adapted to any planar or non-planar geometry of the two parts to be joined.

Additionally, the thermal properties of graphene layers allow their use as an adequate heating source because by applying a small power, the temperature of graphene sheets, and hence the temperature of the substrate where the graphene sheet is located, can be increased in a few seconds.

Temperature and heating time to achieve a requested temperature will depend on the graphene sheet pattern, its size and on the power supplied.

### BRIEF DESCRIPTION OF THE DRAWINGS

To complete the description and in order to provide for a better understanding of the invention, a set of drawings is provided. The drawings form an integral part of the description and illustrate preferred embodiments of the invention. The drawings comprise the following figures.

FIG. 1 shows a schematic view of a graphene heater attached to the front side of a composite panel.

FIGS. 2A and 2B show two embodiments of a graphene pattern.

### DETAILED DESCRIPTION OF THE PREFERRED EMBODIMENTS

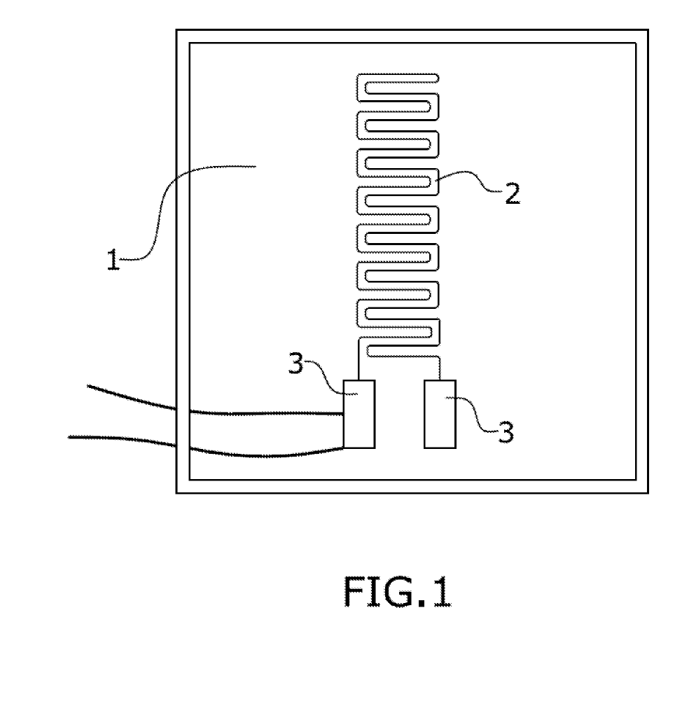

FIG. 1 shows a schematic view of a graphene layer (2) attached to the front side of a composite thermoplastic part (1).

The graphene layer (2) comprises a continuous strand of graphene following an undulated pattern and ending in two connections (3) to an electric current. Additionally, the graphene layer (2) can be embedded in thermoplastic resin to be joined to the composite panel, therefore it can be preimpregnated with resin.

Graphene could be manufactured with a required pattern, over a thermoplastic film compatible with the resin of the parts to be joined so that there won't be any “estrange” material at the interface other than the graphene layer (2). The thickness of the integrated graphene layer (2) is around 50 microns, hence there is no impact on the component tolerances. Available thicknesses of the graphene layer (2) are between 20 microns and 80 microns.

Graphene pattern, length, current voltage and intensity can be fine-tuned to achieve the required thermal field around the interface to be joined. Important parameters of this process are:

1. To control the temperature of the graphene layer (2) in order to heat the interface area of both thermoplastic parts but not the complete thickness of the parts.

2. To control the voltage/amperage/time to fine tune the process.

3. To generate the optimal graphene pattern (foil/net/figure) to melt the whole interface surface in a homogenous way and avoid the presence of weak points due to overheating.

The pattern is one of the parameters that must be determined for each area to be joined, with the objective that all the thermoplastic resin of the area reaches at least the fusion temperature as uniformly as possible. Therefore, the shape of the pattern can vary as long as it fulfills the objective that the whole area to be joined reaches the required temperature.

Additionally, the method object of the invention may further comprise the step of raising the temperature of the two adjacent thermoplastic (1) surfaces above the thermoplastic resin consolidation temperature. The consolidation temperature would be equal to or above the melt temperature.

The method may optionally further comprise a step of applying pressure to the two thermoplastic parts (1) against each other. The applied pressure would be the minimum pressure to achieve an intimate contact between both surfaces to be joined. Ideally, if the contact of both surfaces would be perfect in all their contact area, pressure would be not needed.

The consolidation process hence comprises applying pressure at the consolidation temperature so that the material flows in order to achieve intermolecular diffusion of the material and therefore their joining

If the temperature is raised above thermoplastic resin consolidation temperature, for instance, 300° C.-345° C., for a certain period of time with applied pressure, resin of both parts will then remain linked.

The pattern can be a coil type, like in the attached figures, or straight lines, etc., to define which would be the most optimal design depending on the geometry of the components to be joined.

The graphene layer (2) should be designed with a special configuration depending on the geometry of the thermoplastic parts and heating system (resistive, induction or ultrasonic heating) to distribute heating in a homogenous way around the interface.

Also, it is possible to manage the welding strategy, varying from a continuous welding all along the parts surfaces in contact to a discrete welding to avoid any possible propagation of a crack at the welding area.

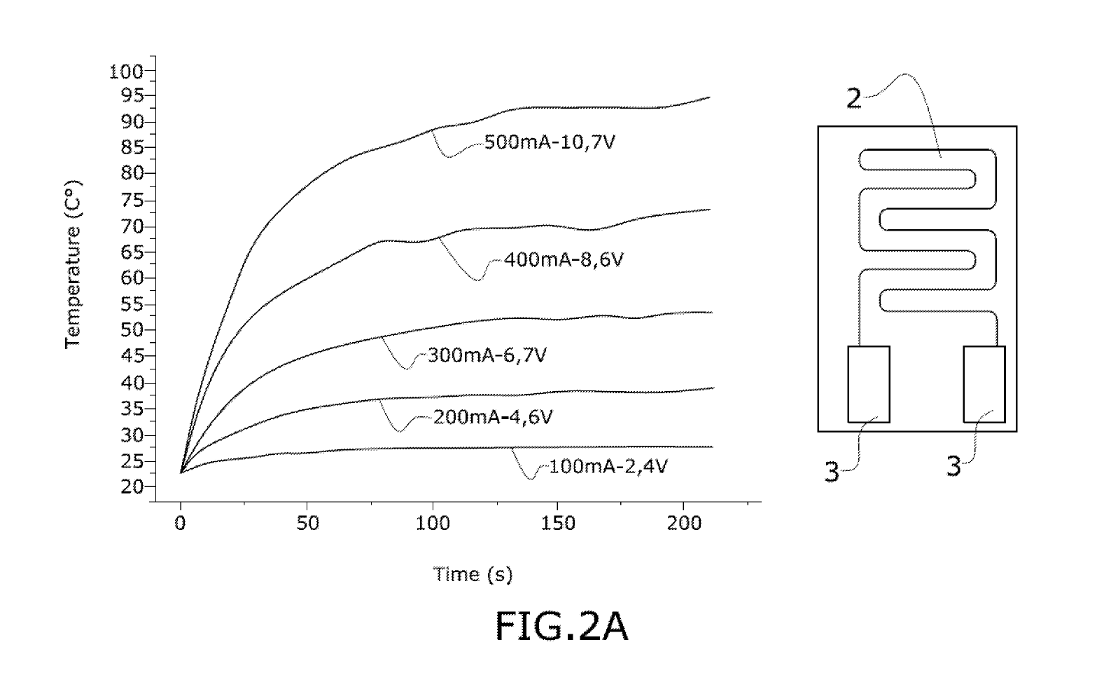

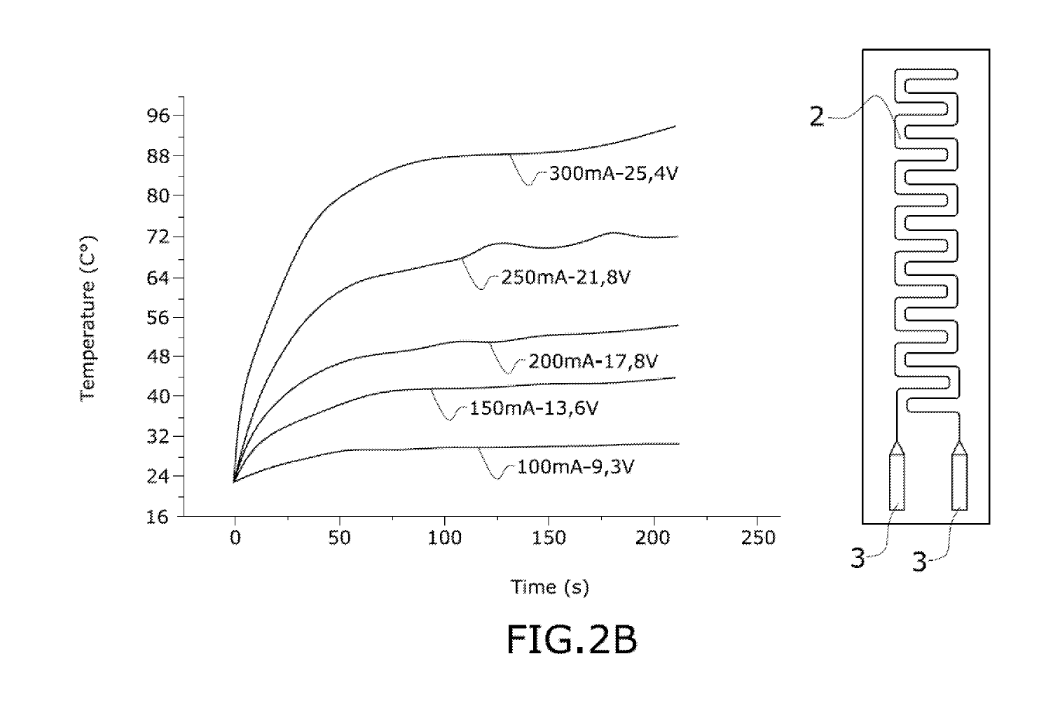

FIG. 2A discloses a graphene layer (2) of 40 mm×60 mm, to which 300 mA is applied and is heated up to 52.5° C. for two minutes. FIG. 2B discloses a graphene layer (2) of 26 mm×160 mm, to which 25.4V/300 mA is applied and is heated up to 89° C. for two minutes.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A joining method for thermoplastic elements comprising the following steps:
providing two thermoplastic parts having two surfaces each comprising a thermoplastic resin to be joined,
locating a graphene layer between the two thermoplastic parts adjacent to the surfaces to be joined,
heating the graphene layer such that the graphene layer melts the thermoplastic resin of the adjacent surfaces of the two thermoplastic parts that are to be joined.

2. The joining method, according to claim 1, wherein the graphene layer comprises a continuous strand of graphene and two connections connected to ends of the strand and configured to be connected to an electric current.

3. The joining method, according to claim 1, wherein the graphene layer is located on a thermoplastic film.

4. The joining method, according to claim 1, further comprising the step of raising a temperature of the two adjacent thermoplastic surfaces above a thermoplastic resin consolidation temperature.

5. The joining method, according to claim 4, further comprising the step of applying pressure to the two thermoplastic parts against each other.

6. The joining method, according to claim 5, wherein the pressure applied is a minimum pressure necessary to achieve an intimate contact between both surfaces to be joined.

7. The joining method, according to claim 1, wherein a thickness of the graphene layer is between 20 microns and 80 microns.

8. The joining method, according to claim 7, wherein the thickness of the graphene layer is 50 microns.

9. The joining method according to claim 1, wherein the graphene layer is heated by applying an electric current to the graphene layer.

10. A joining method for thermoplastic elements comprising the following steps:
providing two thermoplastic parts having two surfaces each comprising a thermoplastic resin to be joined,
positioning a graphene layer between the two thermoplastic parts adjacent to the surfaces to be joined,
moving the two thermoplastic parts towards each other to engage the graphene layer between the two thermoplastic parts,
heating the graphene layer such that the graphene layer melts the thermoplastic resin of the adjacent surfaces of the two thermoplastic parts that are to be joined.

11. The joining method according to claim 10, wherein the graphene layer is configured so as to uniformly heat all the thermoplastic resin of the two surfaces to a fusion temperature of the thermoplastic resin.

12. The joining method according to claim 10, wherein the step of heating the graphene layer is undertaken so as to uniformly heat all the thermoplastic resin of the two surfaces to a fusion temperature of the thermoplastic resin.
